(19) United States
(12) Patent Application Publication
(10) Pub. No.: US 2025/0327510 A1
(43) Pub. Date: Oct. 23, 2025

(54) Cable Drive Linear Positioner

(71) Applicant: Thomas Patrick Moyer, Lagrangeville, NY (US)

(72) Inventor: Thomas Patrick Moyer, Lagrangeville, NY (US)

(21) Appl. No.: 18/641,507

(22) Filed: Apr. 22, 2024

(51) Int. Cl. F16H 19/06

(52) U.S. Cl. CPC F16H 19/0672; F16H 2019/0668

(57) ABSTRACT

A linear positioning drive is disclosed having: low cost, high axial stiffness, zero backlash, high speed capability, high load capacity, long service lifespan, and low heat production. Cost reductions vs. prior art are most significant for drive lengths over one meter. A motor supporting carriage carries a drum sheave held perpendicular to the linear movement direction. Dual cables extend from the drum in parallel but opposite directions at the drum groove helix angle. Cable reeving with multiple dead wraps ensures retention of this cable to groove angular alignment, which in turn, supports long service lifespans for both cable and drum. Each drum rotation moves the dual cable-to-drum departure locations one drum groove pitch, and moves the carriage one groove helix wrap length. Both movements are linearly proportional to any extent of drum rotation. Cable to drum groove alignment is thus maintained over the full range of carriage movement.

### REFERENCE TO RELATED PATENTS

| | | | |
|---|---|---|---|
| 5222316 | Chiou | June | 1993 |
| 3025647 | Moody | March | 1962 |
| 2901764 | Anderson | September | 1959 |
| 2672057 | Bratz | March | 1954 |
| 1042628 | Waybright | October | 1912 |
| 0927695 | Stake | July | 1909 |

### TECHNICAL FIELD

The present invention relates to mechanical drive elements used to translate electrical motor rotary motive force into linear positioner element displacement. These are presented in the prior art for short and intermediate length positioners as being driven by: ball screws, lead screws, acme lead screws, ball splines, glide screws, smooth belts, and toothed belts. Positioners longer than 1 meter are often implemented with rack-and-pinion drives.

The present invention conforms to the class system presented at https://www.uspto.gov/web/patents/classification/selectnumwithtitle.htm as Class Number 074 “Machine element or mechanism:” SubClass 89 “Reciprocating or oscillating to or from alternating rotary:” SubSubClass 89.2 “including flexible drive connector (e.g., belt, chain, strand, etc.):” SubSubSubClass 89.22 “With pulley:”

### BACKGROUND OF THE INVENTION

A longstanding need has existed for linear positioning drives which improve one or more of the performance and cost characteristics of these drives. Substantial engineering and inventive efforts have been expended on each of the several types of belt, cable, screw, and geared rack solutions. These efforts have established the drive length and application spaces wherein each of the drive technologies are the low cost implementation of desired sets of performance characteristics. The present invention overcomes several of the limitations of each of the positioning drive prior arts.

Belt drives are commonly found on low cost, entry level CNC machines which are thus limited to machining wood, plastics and soft metals. The belts are not axially stiff enough to prohibit excessive positional displacement when encountering the higher forces from tool bit end effectors interacting with harder metals. The low stiffness of belts becomes a drive length limiter, as a load under a given force, will displace by an amount directly proportional to the driving belt length.

The several types of screw drives transmit compressive force down the long thin axis of the screw. Per Euler's column formula, to avoid bending, the diameter of the screw needs to increase proportional to the length squared. This imposes substantial parasitic rotational inertia for long screws. The precision machining of low friction ball screws along their full length, becomes prohibitively expensive at lengths of about a meter. The lower cost acme lead screws operate with substantial friction between the screw and the nut. This requires higher force motors to be employed. The heat produced by this friction can limit operating speeds. The force which can be exerted by any of the screw drives can be no greater than that which can be supported by the thrust bearings restricting the axial movement of the screw.

### SUMMARY OF THE INVENTION

Long length rack-and-pinion positioning systems use the ability of the rack to be assembled from rack segments which are precision aligned one to the other. The cost of such a multi-segment rack is substantially less than a single long precision machined rack. Each of these segments does however still need to be precision machined to gear tolerances over the rack segment length giving rise to substantial cost. Backlash is an additional detrimental aspect of these systems even when the pinion is directly driven by the motor.

The present invention is an efficient and low cost translator of rotary motion into linear motion. The prescribed embodiment components are a motorized helically grooved drum held perpendicular to the linear motion, with tensioned cable extensions departing the drum at the same angle as the drum helical groove angle, i.e. zero fleet angle. Cable reeving which includes three or more drum dead wraps is key to maintaining the fleet angle at negligible fleet angles without excessive maintenance requirements. The prescribed geometric component relationship combined with appropriate reeving ensures that, over the full linear motion range, fleet angles supporting long cable and drum service life occur and are maintained.

The present invention provides a conversion from rotary motor motion to linear motion with low heat production, high axial stiffness, using a single layer wrap on a grooved drum sheave. The most preferred cable is wire rope because of the low cost per length, easy availability of several diameters, high working strength, high modulus of elasticity, with a well characterized and long service lifespan in drum sheave applications. The availability of multiple cable diameters allows an application designer to balance several drum diameter dependent performance characteristics. The application envelope economically includes many currently employed additive and subtractive machining applications such as CNC machining, plasma arc cutting, laser etching, laser cutting, and 3D printing. As the ratio of drum to cable diameters increases, cable service lifespan increases but the force available from a given motor is inversely proportional to the drum diameter. The most preferred connection between the motor and the drum is to have a backlash-free rotationally stiff flexible coupling which results in an overall backlash free embodiment.

Applications requiring modest multipliers of the force available from direct drum drive force transmission can use the classic block and pulley arrangement. This is a mechanically advantaged, multiple pulley, multiple cable loop arrangement between the frame and the carriage. Application of such an arrangement to the present invention requires the number of cable transitions between any frame mounted and any carriage mounted pulleys to be same on both sides of the drum. Such an arrangement does not introduce backlash into the system. Applications requiring large multiplies of the force available from direct drum drive force transmission can use geared transmissions at the cost of introducing backlash.

One aspect of the present positioning invention is how it stands in contrast with the reciprocating machine of Stake 1909. Stake neither discloses, claims, nor illustrates the cable departure angle as being equal to the drum sheave helical angle. One of his cable extensions does depart at the helical angle, but the other extension is shown as being 5 degrees different from the helical angle. This level of misalignment would result in severe service life reduction for both the cable and the drum. A second differentiator is that Stake has no need for, and neither discloses, claims, nor illustrates means to impose or hold the cable in tension. His device achieves the desired reciprocating action even if the cables sag by several centimeters. The effect of such a sagging cable would be to increase somewhat the table backlash already inherent in his belt driven transmission.

The alignment of the cable extensions to the drum helix angle will become degraded if and when the cable migrates from an initially aligned reeving, Two sources of misalignment introduction are identified: cable movement relative to the drum from asymmetric loading, and cable stretch which happens to a limited extent over substantial times. The former is referred to as cable creep. The present invention comprises means to mitigate application induced cable extension misalignment.

Cable creep arises from asymmetric force application to the cable and drum interaction. With each application of motor force, and with each occurrence of end effector load, the cable extensions experience a slight lengthening of one of the extensions and a slight length contraction of the other cable extension. The rotation of the drum always entrains the extension on the elongated side. If the reeving allows, and the drum rotates enough, the stretched portion of the cable can become part of the extension on the other side of the drum. In such a circumstance the cable will have advanced along the drum groove by a small amount, that amount being a fraction of the stretch length. In an application wherein either the acceleration profile or the load conditions are asymmetric, these incremental displacements can accumulate to produce significant cable shifting along the wrap groove of the drum. This manifests as misalignment of the cable extensions away from the drum helix angle.

A second cause of cable extension angular misalignment is the permanent cable stretching which occurs with the repeated bending and unbending of multifilament cables, such as wire rope, as they are wrapped onto and off of the drum. This permanent cable stretching changes the position of the carriage relative to the frame by shifting it away from the less compliant of the cable frame attachments. This, in turn, degrades the extension alignment to the helix angle. Periodic maintenance can correct this misalignment.

### BRIEF DESCRIPTION OF DRAWINGS

FIG. 1 is a top orthographic view of an illustrative embodiment

FIG. 2 is a perspective view of the embodiment in FIG. 1

FIG. 3A is a top orthographic view of an alternative tensioner

FIG. 3B is a perspective view of the tensioner in FIG. 3A

FIG. 4 is a side orthographic view of the embodiment in FIG. 1

FIG. 5A is a top orthographic view of an embodiment with an alternate tensioner

FIG. 5B is as side orthographic view of the embodiment in FIG. 5A

FIG. 6A is a top orthographic view of a drum sheave with cable reeving at mid travel

FIG. 6B is a top orthographic view of the reeved drum of FIG. 6A at a travel extreme

FIG. 6C is a top orthographic view of the reeved drum of FIG. 6A at the other travel extreme

FIG. 7A is a top orthographic view of a drum sheave with an alternate reeving at mid travel

FIG. 7B is a top orthographic view of the reeved drum of FIG. 7A at a travel extreme FIG. 7C is a top orthographic view of the reeved drum of FIG. 7A at the other travel

extreme

FIG. 8A is a top orthographic view of a drum sheave with an alternate reeving at mid travel

FIG. 8B is a top orthographic view of the reeved drum of FIG. 8A at a travel extreme

FIG. 8C is a top orthographic view of the reeved drum of FIG. 8A at the other travel extreme

FIG. 9A is a top orthographic view of a drum sheave with alternate reeving near mid travel

FIG. 9B is a top orthographic view of the cable only from the reeving of FIG. 9A

FIG. 9C is an axial perspective view of cable only from the reeving of FIG. 9A

FIG. 10 is an orthographic illustration of an alternative tensioner

### DETAILED DESCRIPTION OF THE INVENTION

The following paragraphs describe the present invention with references to the attached drawings. The drawings present advantages and geometric relationships of exemplary implementations of the present invention but should not be taken as limiting the scope of the invention. Similarly, except where noted otherwise, variants of all terms, including singular forms, plural forms, and other affixed forms, fall within each exemplary term meaning. Except where noted otherwise, capitalized and non-capitalized forms of all terms fall within each meaning.

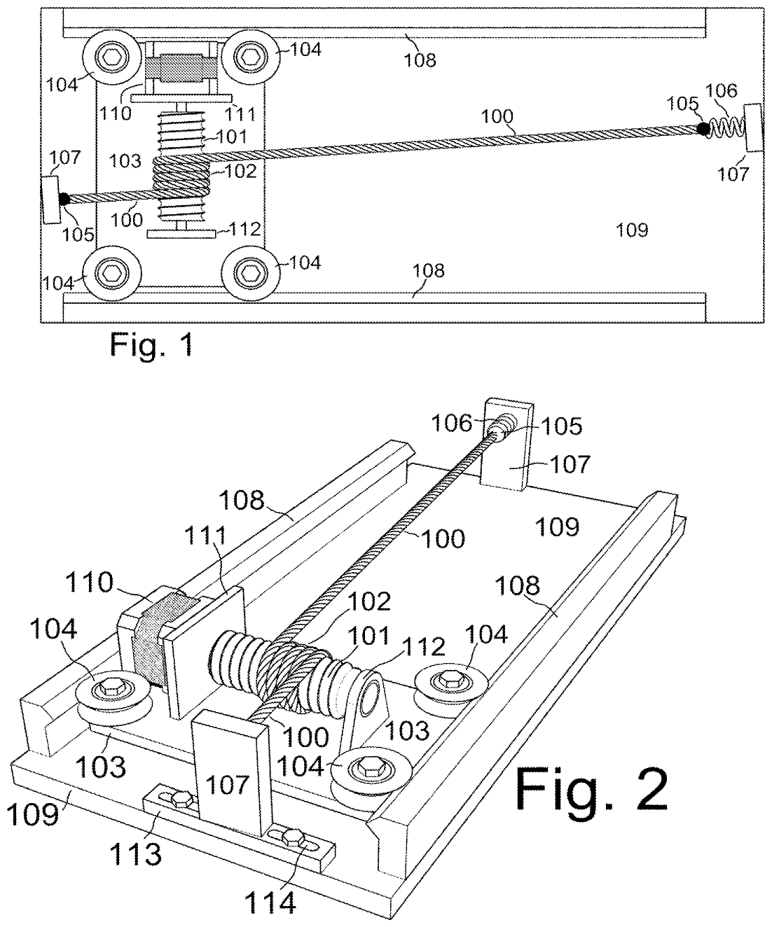

FIGS. 1 and 2 depict an illustration of the salient features of the present invention. cable 100 is illustrated as a wire rope reeved around uniformly helically grooved drum 101, said reeving includes multiple wraps 102. Carriage 103 uses V-grooved wheels 104 for both low friction movement relative to frame 109 along linear motion rails 108, and maintenance of the alignment of the drum 101 grooves to the cable 100 extensions which span between the drum 101 and the cable attachments 105. The attachments 105 are depicted as simple spheres, as their construction details are not pertinent to the present invention. Tensioning means 106 is affixed to a cable tension resisting block 107, as is the cable attachment 105 at end of the other cable 100 extension. Tensioning means 106 on one and only one end of cable 100 is sufficient to tension both cable 100 extensions from the drum. Tensioning means 106 is depicted as a spring for illustrative clarity, but the low elastic modulus of a spring tensioner is a non-preferred embodiment. Electric motor 110 is responsive to inputs from electronic control circuitry (not shown) rotating the drum, and through friction applies force to the cable 100 extensions. The motor 110 and drum 101 are fixed to the carriage 103 by motor mounting plate 111 and drum pillow block 112.

The linear motion is defined as the relative motion, along a linear path, of the carriage 103 relative to the frame 109, that motion holding the drum supporting member in a fixed angular relation to the linear motion direction.

The drum carrier is defined as that member of the carriage 103 or frame 109 which supports the drive motor 110 and drum 101.

The V-grooved wheels 104 and linear rails 108 are depicted as the linear motion means. These elements were depicted as the linear guide means because they are relatively easy to draw. Any linear guide technology able to restrain the drum axis from rotating relative to the linear motion, while enabling low friction motion of the carriage 103 relative to the frame 109 would appropriately embody the present invention linear guide means. Examples of alternate guides which embodiments of the present invention could use are: recirculating ball bearing guides, wheels in grooves, recirculating roller guides, linear air bearings, crossed roller bearings, linear ball rails, and multiple wheels surrounding guide tubes.

Cable alignment bracket 113 can adjust the cable 100 alignment by being clamped at an appropriate location in the elongated hold down holes 114. The illustration shows the alignment bracket 113 at only one end of the cable 100 extensions for clarity of illustration. Preferred embodiments would allow cable alignment adjustments transverse to the linear motion as this would allow for easier cable 100 installation, alignment, and maintenance procedures. Alternate cable alignment means (not shown) would allow repositioning of the motor and drum assembly perpendicular to the linear motion.

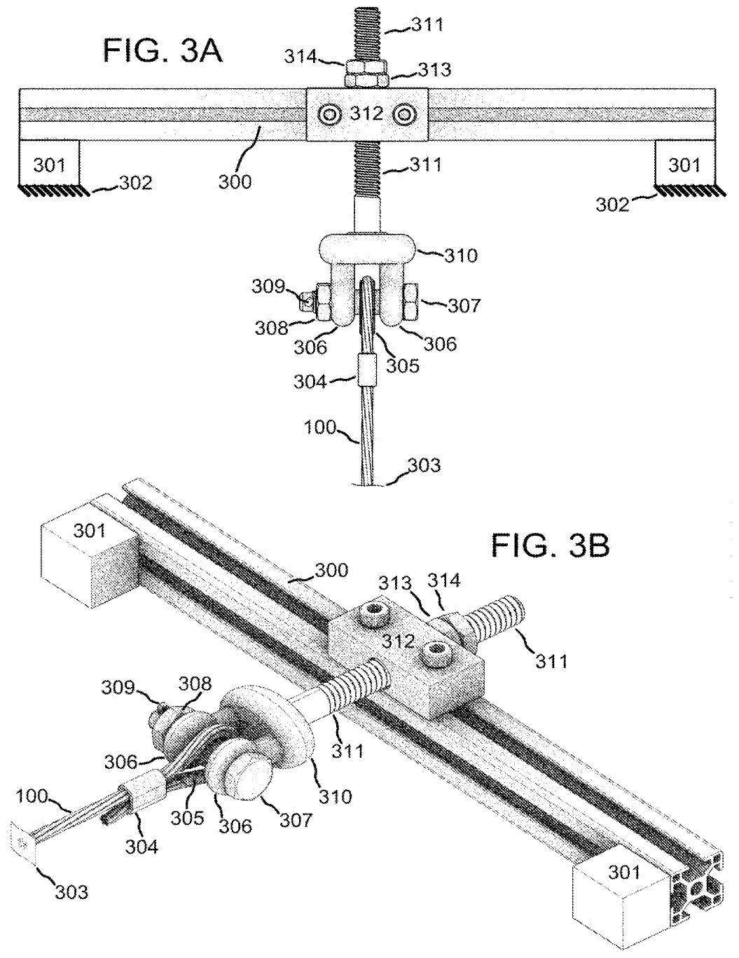

FIGS. 3A and 3B depict a preferred tensioner where elastically bending frame member 300 transfers force from cable 100 to rigid frame supports 301 as indicated by rigidity indica 302. Cable extension indicator 303 designates the transition between the portion of cable 100 depicted in the figure, and that portion of the cable 100 outside the figure depicted region.

Sleeve 304 and thimble 305 resist cable 100 tension imposed through clevis pin 307 which is held in place with nut 308 and cotter pin 309. Tension is conveyed through dual arms 306 to flange 310 and then to partially threaded shaft 311. Position of shaft 311 relative to block 312 is determined by nut 313 and tensioning lock nut 314.

Tension on cable 100 can be adjusted by extending or retracting shaft 311. Angular position of cable 100 relative to drum 101 (outside the region shown in this figure) can be adjusted by changing the position of block 312 relative to elastically bending frame member 300.

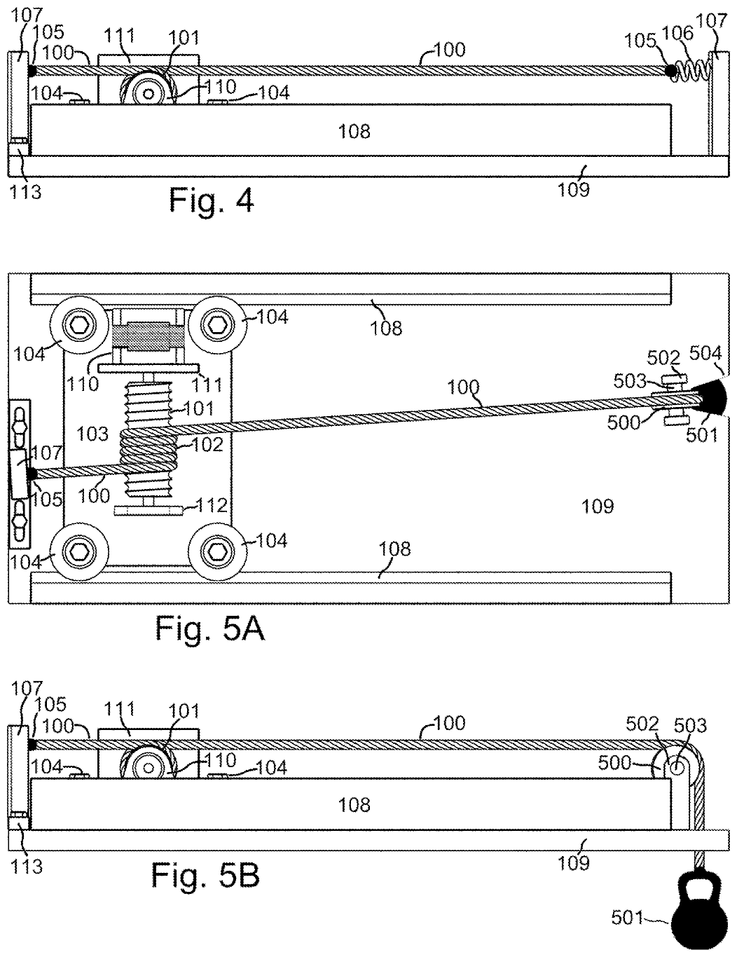

FIG. 4 is an orthographic side view of the same embodiment in FIGS. 1 and 2. It shows the most preferred orientation of the two cable 100 extensions from the drum 101: that orientation being parallel to the plane traversed by the drum 101 axis during the linear motion. Cable attachments 105 which are higher or lower than the height at which the cable 100 departs from the drum 101 offer no advantage and cause undesirable diminution of the force transmitted from the motor 110 into carrier motion.

FIGS. 5A and 5B are orthographic views of an embodiment of the present invention having the most preferred cable tensioning means for cable drive linear positioners having a non-motile frame 109. The non-motile frame condition is fulfilled by the base axis on moving gantry machines, and by both the moving bed lowest axis and the gantry spanning axis for fixed gantry machines. Pulley 500 is supported by stand 502 and pulley axle 503 allows conversion of the downward force from suspended weight 501 into tensioning force within the plane traversed by the drum axis. Access notch 504 allows an extension of cable 100 to hang over pulley 500.

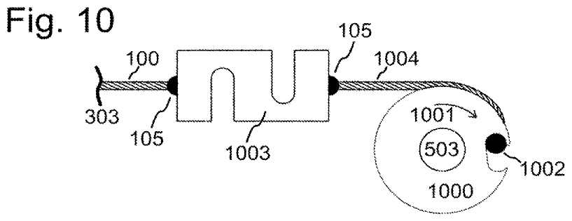

The free hanging suspended weight 501 of FIG. 5A and FIG. 5B is contraindicated for applications in which the frame 109 is motile. Example applications which have a linear positioner with a motile frame 109 are the gantry axis in a moving gantry application, and as the third (often Z) axis in both mobile gantry and stationary gantry applications. The mass of the suspended weight 501 would decrease the ability of the supporting axis (the one that is moving the motile frame 109) to accelerate and decelerate. The free swinging weight 501 could also have detrimental effects on neighboring components. A preferred embodiment would restrain the suspended weight 501 in a short vertical linear slide. This addresses the swinging damage aspect, but does not address the inertia imposing mass carried by the supporting mover. The most preferred cable tensioning element embodiment for a motile frame 109 is illustrated in FIG. 10 and is discussed below.

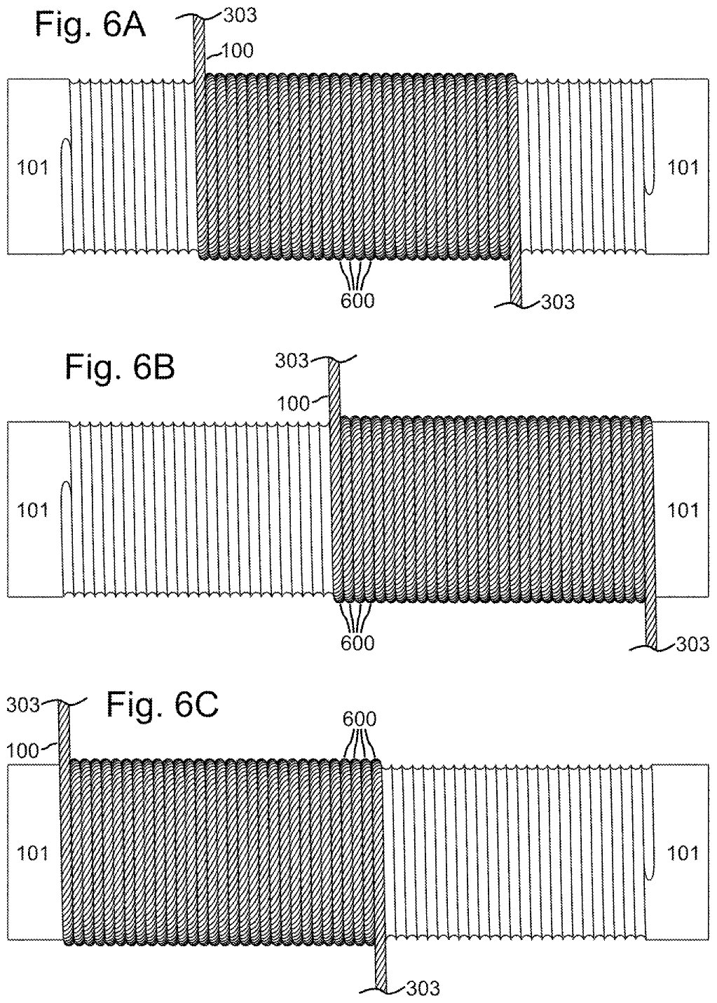

FIGS. 6A, 6B, and 6C show a preferred embodiment of cable 100 wraps around drum 101 wherein the cable has a number of wraps substantial enough to support both dead wraps as well as live wraps. Standard reeving practice for wire rope cables is to have a minimum of 3 dead wraps, those wraps which do not become detached from their static position on drum 101 during the full range of drum rotation induced cable extension and retraction. The live wraps are those which are spooled off of, or onto, drum 101 as drum 101 rotates. Four dead wraps 600 are shown in each of the 6A, 6B and 6C figures. The presence of the dead wraps prevents cable creep as they disallow the stretched portion of the cable 100 from migrating along the drum groove and being relieved by disengaging from the drum 101 on the opposite end of the cable 100 to drum 101 contact. The length of cable needed for this preferred reeving is roughly twice the length of the linear motion, plus the length of the dead wraps 600. The length of drum 101 needed is that length which supports a helical groove length equal to the length of the linear motion plus the width of the several dead wraps 600. The substantial distance between the two locations at which the cable 100 departs from the drum 101 impart significant torque on the drum. The need for the linear guide means to resist this parasitic torque is why this is not a most preferred embodiment.

FIG. 6A shows the cable 100 and drum 101 set with cable 100 having equal lengths extended on the left and right sides of the dead wraps. This condition also has equal number of live wraps on both sides of the dead wraps. This corresponds to the drum carrier being in the middle of it's motion range.

FIG. 6B shows the same embodiment after the drum has rotated such that all of the cable 100 in the live wraps on the left side of the dead wraps have extended off the drum 101, and the grooves to the right of the dead wraps are fully entrained with cable 100 live wraps. This corresponds to the drum carrying carrier being at one of the extremes of the linear motion range.

FIG. 6C shows the same embodiment after the drum has rotated such that all of the cable 100 in the live wraps on the right side of the dead wraps have extended off the drum 101, and the grooves to the left of the dead wraps are fully entrained with cable 100 live wraps. This corresponds to the drum carrier being at the other of the extremes of the linear motion range.

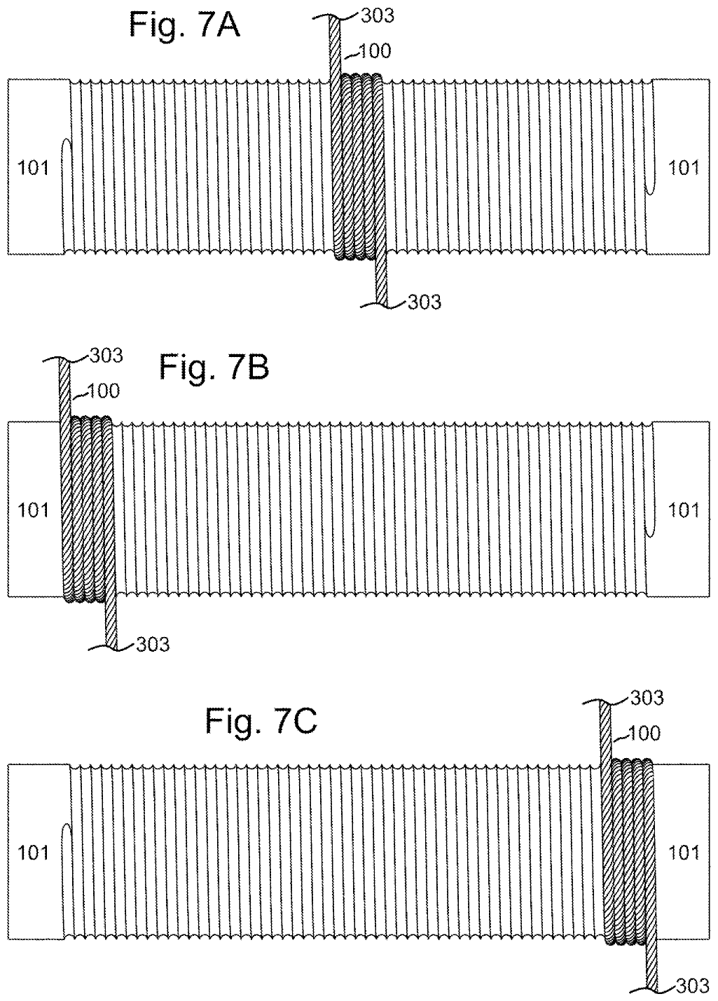

FIGS. 7A, 7B, and 7C show a non-preferred embodiment of cable 100 wraps around drum 101 wherein the cable has only live wraps, as the number of wraps is insufficient to support any dead wraps. This reeving allows cable creep as the stretched regions of the cable 100 incrementally move along the drum 101 helical groove as these stretched regions reach the non-stretch inducing end of the cable 100 to drum 101 contact. If and only if the embodiment use profile includes movements which impose opposite creep inducing motions will the cable remain in the desired aligned state.

This reeving does have two small cost savings over the preferred reeving embodiments. The cable length needed is the linear motion length, plus the helical groove length of the small number of wraps. The required drum 101 length is also smaller, needing to support only a helical groove length equal to the linear motion length plus the width of the several reeved wraps. The susceptibility of this reeving to cable creep contraindicates its use in any applications which have asymmetric loading. Even those applications expected to have fully symmetric force profiles need to ensure frequent maintenance activities to detect and correct the misalignment.

FIG. 7A shows the cable 100 and drum 101 set with cable 100 having equal lengths extended from drum 101. This corresponds to the drum carrier being in the middle of the linear motion range.

FIG. 7B shows the same embodiment after the drum has rotated such that all of the cable 100 wraps are on the left end of the drum 101. This corresponds to the drum carrier being at one of the extremes of the linear motion range.

FIG. 7C shows the same embodiment after the drum has rotated such that all of the cable 100 wraps are on the right side of the drum 101. This corresponds to the drum carrier being at the other of the extremes of the linear motion range.

An embodiment of the present invention which includes this reeving, and which operates within the broad range of applications expected to encounter asymmetric loading, without the need for excessively frequent cable misalignment maintenance is possible. Such an embodiment would be made possible by having automated misalignment detection through use of electromechanical detectors or by computer vision, combined with an automated motorized realignment means. Such an implementation is viewed as being overly complicated and less preferred to the reevings presented below.

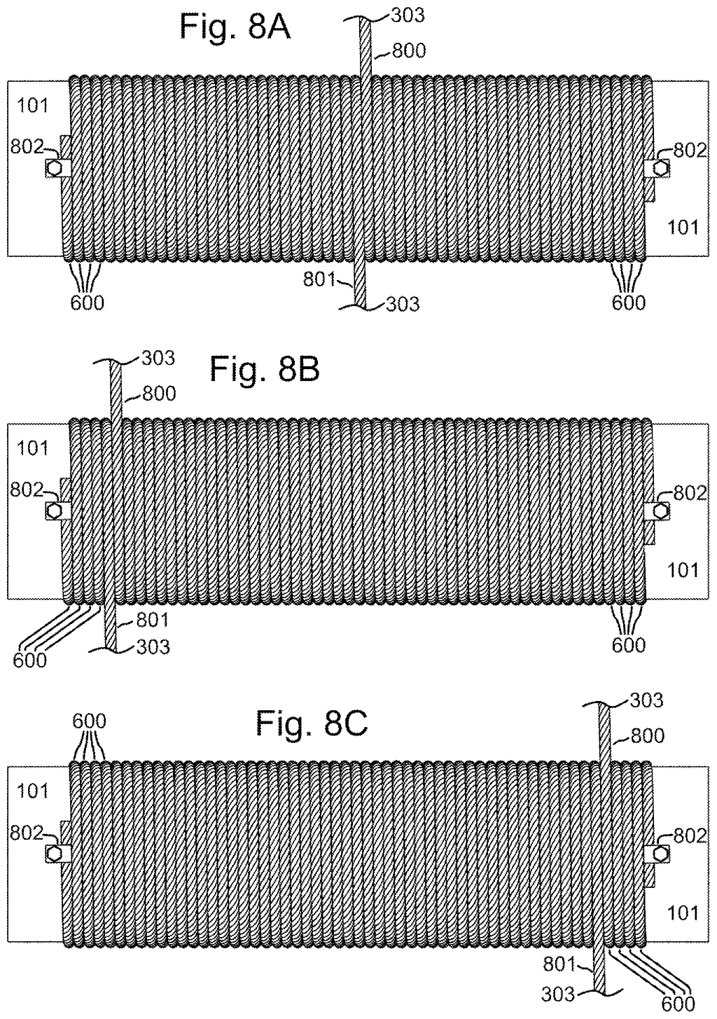

FIGS. 8A, 8B, and 8C shows a preferred cable reeving arrangement in which two cables 800 and 801 each have an end secured to the drum 101 by clamps 802 with the first several wraps as dead wraps 600, here shown as four dead wraps. This reeving is inspired by the steering wheel shaft wire rope drum sheave of the classic power boat: the Boston Whaler. Each of the two cables proceed through successive wraps toward each other and then extend beyond the drum 101. The reeving shown is a maximal quantity of cables 800 and 801 on the drum 101, with the departure locations of the cables 800 and 801 from the drum 101 at a single drum helical groove periodicity. Reeving with cableless drum 101 helical groove periodicities between the drum departures of the two cables serves no advantage, and disadvantageously increases the torque which must be resisted by the linear guide means.

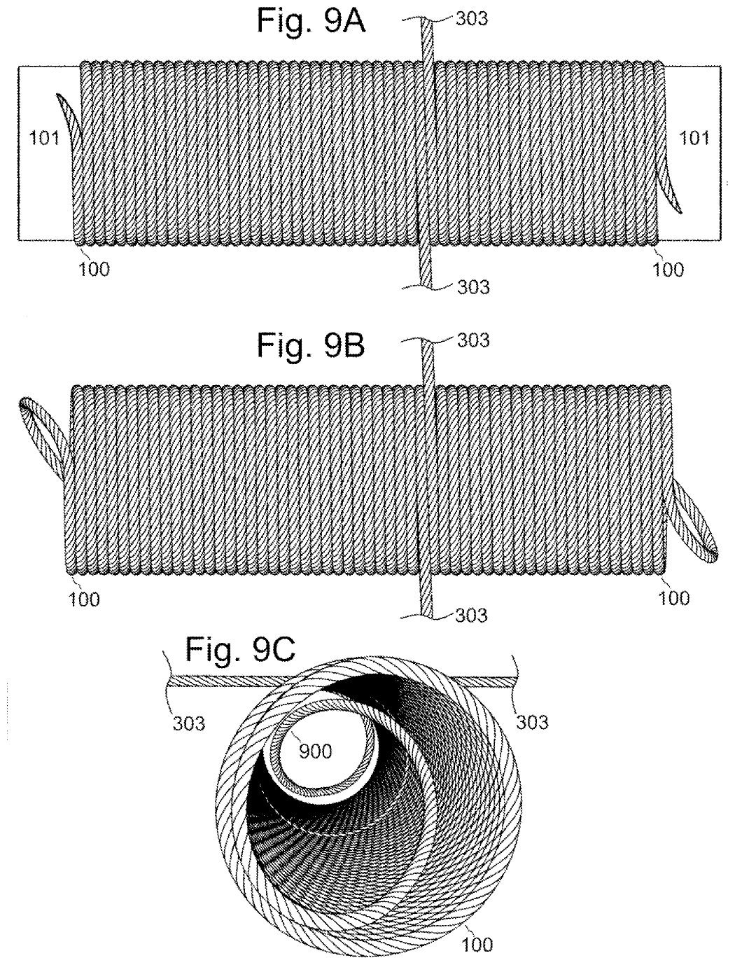

FIGS. 9A, 9B, and 9C show the most preferred arrangement of cable and drum sheave. A single cable passes into a channel or other opening near the end of the drum 101, and passes through the interior of the drum 101, and exits the drum 101 near the other end. An amount of cable sufficient to wrap half of the drum 101 helical grooves and extend from the carrier half of the linear motion distance extent is pulled through the drum. The two lengths of cable extending from the two ends is wrapped around the drum until they occupy adjacent helical groove periodicites. FIGS. 9B and 9C show only cable 100, as though the drum 101 has become invisible. The most preferred internal helical path 900 of the cable 100 gives a minimally kinking path for the cable to be fed from one end of the drum 101 to the other end. The helical path 900 could be formed in 3D printed drums 101 or by using investment casting for metal drums. When drum 101 is formed from tube, end caps can have openings which allow reeving the cable axially within the body of drum 101.

FIG. 10 illustrates the most preferred embodiment of a tension imposing means for a cable drive linear positioner with a motile frame 109. Motorized cable attachment pulley 1000 (motor not shown) holds cable extension 1004 by attachment 1002 and rotates around axis 503. Rotation indication arrow 1001 shows the unidirectional nature of the force imposed through pulley 1000. Because this force is unidirectional, the pulley 1000 can be employed through a transmission technology normally characterized by substantial backlash such as a worm gear. A pinioned gear transmission can also be employed. Because unidirectional pull obviates any backlash imposition by force multiplying transmissions, motors small in relation to the drive cable motor can be employed. Cable 100 and cable 1004 are affixed to strain gauge 1003 by attachment means 105. In operation, an automated feedback loop us used to impose and maintain appropriate stress on cable 1004 by moving the pulley 1000 in the 1001 direction until the strain measured by gauge 1003 reaches an appropriate level.

What is claimed is a cable drive linear positioning appliance comprising:

1. A frame and a carriage which move relative one to the other on a linear path over a fixed range; the carriage or frame supporting a shafted rotary motor and a drum sheave; the drum rotary axis being held perpendicular to the direction of linear motion; the drum having one or two cable entraining helical grooves on the cylindrical surface thereof; the motor operationally connected to the drum such that rotation of the motor shaft results in a proportional rotation of the drum after any backlash in the motor to drum connection has been overcome; the motor being operationally responsive to electronic circuitry which imposes time dependent direction and rotational extent control over the motor in response to at least one external input; one or two cables entrained in a drum groove and wrapped at least three quarters of one complete turn around the drum; two cable extensions departing from the drum and attaching to the other of the carriage or frame at cable extension angle imposing elements; the extensions departing in directions which orthographically project onto the geometric plane containing the drum axis movement locus; said projections being parallel but in opposite directions, the extension projection angular parallelism being less than six degrees radial one from the other; cable extension angle imposing elements which act cooperatively with other appliance components to maintain the cable extension departure angles at less than 3 degrees difference from the drum departure location groove helical angle over the full range of carriage to frame relative movement; cable-extension-to-member attachments at fixed locations on the non-motor supporting member of the carriage and frame; the attachments imposing tension on the cable extensions preventing slack cable conditions.

2. The appliance of claim 1 in which: the cable extensions are co-planar.

3. The appliance of claim 1 in which: the cable tension imposing means is an elastically deformed element.

4. The appliance of claim 1 in which: the cable tension imposing means is a cable suspended weight.

5. The appliance of claim 1 in which: the cable tension imposing means is a motorized rotary element, in which the motor rotational extent is responsive to a cable tension measuring electronic sensor.

6. The appliance of claim 1 in which: a single cable extends from a first cable angle imposing element to the drum, with a further distal portion of the cable entrained in a drum groove, and wrapping around the drum at least three quarters of one complete turn, with a yet further distal portion of the cable extending from the drum to a second cable angle imposing element.

7. The appliance of claim 6 in which: a single cable extends from a first cable angle imposing element to the drum, with a further distal portion of the cable entrained in a drum groove, and wrapping around the drum at least three complete turns, with a yet further distal portion of the cable entrained in a drum groove, and wrapping around the drum at least as many turns as entrain enough cable to be of the same length as the path over which the carriage and frame relatively move, with a yet further distal portion of the cable extending from the drum to a second cable angle imposing element.

8. The appliance of claim 1 in which: An end of a first cable is affixed to the drum near a first axial end of the drum with a portion of the first cable entrained in a drum groove, and wrapping around the drum at least three complete turns, with a yet further distal portion of the first cable entrained in a drum groove, and wrapping around the drum at least as many turns as entrain enough first cable to be of the same length as the path over which the carriage and frame relatively move, with a yet further distal portion of the first cable extending from the drum to a first cable angle imposing element and; an end of a second cable affixed to the drum near the second axial end of the drum with a portion of the second cable entrained in a drum groove, and wrapping around the drum at least three complete turns, with a yet further distal portion of the second cable entrained in a drum groove, and wrapping around the drum at least as many turns as entrain enough cable to be of the same length as the path over which the carriage and frame relatively move, with a yet further distal portion of the second cable extending from the drum to a second cable angle imposing element.

9. The appliance of claim 1 in which: a single cable extends from a first cable angle imposing element to the drum, with a further distal portion of the cable entrained in a drum groove, and wrapping around the drum at least as many turns as entrain enough cable to be of the same length as the path over which the carriage and frame relatively move, with a yet further distal portion of the cable traversing the axial length of the drum interior to the smallest radius of the drum cylindrical grooved surface, with a yet further distal portion of the cable entrained in a drum groove, and wrapping around the drum at least as many turns as entrain enough cable to be of the same length as the path over which the carriage and frame relatively move, with a yet further distal portion of the second cable extending from the drum to a second cable angle imposing element.
